(19) United States
(12) Patent Application Publication
(10) Pub. No.: US 2008/0158134 A1
(43) Pub. Date: Jul. 3, 2008

(54) Display Device and Method, Key, Keyboard and Electronic Device Using Same

(76) Inventor: David Luo, Nimes (FR)

Correspondence Address: LERNER GREENBERG STEMER LLP, P O BOX 2480, HOLLYWOOD, FL, 33022-2480, US

(21) Appl. No.: 11/816,057

(22) PCT Filed: Feb. 10, 2006
(86) PCT No.: PCT/IB2006/000256

§ 371 Date: Aug. 10, 2007

(30) Foreign Application Priority Data
Feb. 10, 2005 (FR) PCT/FR2005/000297
Oct. 13, 2005 (FR) 0510472

(51) Int. Cl. G09G 3/36

(52) U.S. Cl. 345/102

(57) ABSTRACT

The invention concerns a display device comprising: at least one so-called upstream filter bearing a message to be displayed, a light source adapted to illuminate each said filter through backlighting, a partly reflecting element located downstream of at least one upstream filter such that, when the light source is switched off, the message borne by each upstream filter, masked by the partly reflecting element, is not visible and, when the light source is switched on, a message borne by an upstream filter is visible. In some embodiments, the partly reflecting element is integrated in the second filter or located upstream of the second filter such that, when the light source is switched off, the message borne by the second filter is visible and, when the light source is switched on, a message borne by an upstream filter is visible. In particular embodiments, the partly reflecting element is integrated in one of said filters, the outline of the message to be displayed being defined by the outline of a partly reflecting zone integrated with said filter.

The present invention is aimed at a display device and method, a key, a keyboard and an electronic device implementing them. It applies, in particular, to portable electronic apparatuses possessing several operating modes, for example telephone and games, telephone and remote control, radio, portable television, portable music player, positioning system, games console, personal digital assistant, terminal for accessing the Internet and public displays, such as advertising panels or road signs, etc.

Portable electronic apparatuses are subject to miniaturization requested by users and allowed by technological progress. The keyboards of these apparatuses are therefore tending to be miniaturized, thus making them difficult to use: the spacing between two keys is of the same order of magnitude as the diameter of the fingers, so that the number of input errors is significant and/or the number of keys is much reduced and the inputting of each symbol requires several presses of the keyboard. For example, to allow input of the 26 letters with a keyboard comprising a dozen keys, several keys must correspond to at least three letters, not counting letters with accents.

Moreover, the number of operating modes of portable electronic apparatuses is increasing: portable telephones are incorporating cameras, diaries, calendar managers, games, etc.

The keyboard of these electronic apparatuses, that is dedicated to the main function, for example telephony, is not suited to the other operating modes in which the keyboard symbols to which users are accustomed are different.

Finally, it is not possible to present, on each key of the keyboard, all the symbols to which the keyboard key ought to correspond, as this might make them unreadable.

In advertising panels or public displays or road signs, when one wants to be able to display several messages, it is necessary either to juxtapose them, or to scroll these messages, for example by motorizing a means for displacing the message supports. These systems are expensive, occupy significant space or display messages of small dimension that is detrimental to their recognition.

The present invention is aimed at remedying these drawbacks.

For this purpose, the present invention is aimed, according to a first aspect, at a display device which comprises:
at least one filter termed “upstream” carrying a message to be displayed,
at least one second filter carrying a message to be displayed,
a light source suitable for illuminating each said filter, by backlighting,
a partially reflecting element placed downstream of at least the upstream filter

in such a manner that, when the light source is turned off, the message carried by each upstream filter, masked by the partially reflecting element, is not visible and, when the light source is turned on, a message carried by an upstream filter is visible.

According to particular characteristics, the partially reflecting element is integrated into the second filter or placed upstream of the second filter in such a manner that, when the light source is turned off, the message carried by the second filter is visible and, when the light source is turned on, a message carried by an upstream filter is visible.

By virtue of these arrangements, a message appears by default, under ambient light and to reveal another message, for example a symbol, on one of the keyboard keys or a message on a display panel, the light source is turned on and, possibly, the characteristic of the light source is modulated in order that this characteristic corresponds to the filter representing said message or symbol or said message.

Moreover, each message displayed can thus occupy visually, for the user, the major part of the display surface and, in any case, a footprint that overlaps, at least partially, the footprint of the other messages corresponding to the other filters.

According to particular characteristics, the partially reflecting element is integrated into the second filter, the contour of the message to be displayed being defined by the contour of a partially reflecting zone integrated with said second filter.

According to particular characteristics, at least two of said filters are superimposed in the display surface.

According to particular characteristics, at least two of said filters consist, each of a set of filters, said filter sets being juxtaposed alternately in the display surface.

According to particular characteristics, the device as succinctly set forth above comprises at least one contactor suitable for providing a signal representative of the interaction between a user and at least one part of the display surface.

By virtue of these arrangements, the device can constitute an electrical button, a push-button, a contactor, a keyboard, a key, for example.

According to particular characteristics, the device as succinctly set forth above comprises a plurality of keys comprising a said contactor. A keyboard is thus constructed.

According to particular characteristics, the display device as succinctly set forth above comprises a means for modulating at least one physical characteristic of said light source, at least two filters, each corresponding to a value of physical characteristic modulated by the modulation means and to a message to be displayed on said display surface.

By virtue of these arrangements, turning on the light source makes it possible to display a plurality of messages according to the switching performed by the switching means.

According to particular characteristics, the modulation means is suitable for varying the luminous spectral band which reaches said filters and said filters exhibit different spectral transparency bands.

By virtue of these arrangements, when the modulation means varies the spectral band of the light rays which reach the filters, the latter take different visual appearances, this having the effect of revealing different symbols or messages in the display surface, for example on the keyboard key, with which these filters are associated or on the display panel comprising these filters.

According to particular characteristics, the light source comprises a light-emitting diode whose spectral emission band varies as a function of the electrical characteristics of the feed signal which is applied to it and the modulation means is suitable for varying said electrical characteristics.

By virtue of these arrangements, the construction of the light source, of the optical system and of the modulation means are simplified.

According to particular characteristics, the light source comprises at least two independent electro-optical transducers placed in parallel on an optical path of light rays originating from the light source and reaching the display surface, the modulation means being suitable for alternately controlling the emission of light by one or the other of the electro-optical transducers.

By virtue of these arrangements, the colors of the symbols or messages displayed alternately can be identical, the switching of the electro-optical transducers causing their successive displays.

According to particular characteristics, the modulation means is suitable for varying a main polarization axis of the light rays reaching the filters and the filters exhibit different transparencies according to the polarization axes. By virtue of these arrangements, the various symbols or messages displayed alternately on the same display surface can exhibit the same colors.

According to particular characteristics, the light source comprises a plurality of electro-optical transducers furnished with optical fibers whose outputs form different symbols on the display surface, the modulation means being suitable for causing light to be emitted by one of said electro-optical transducers.

By virtue of these arrangements, the keyboard can be very slender.

According to particular characteristics, the filters comprise components suitable for achieving constructive or destructive interferences according to the angle of incidence of the light rays and the modulation means is suitable for varying the angle of incidence of the light rays emitted by the light source.

According to particular characteristics, the filters comprise holograms and the light source comprises at least two electro-optical transducers suitable for illuminating said holograms with different angles of incidence so as to reveal various symbols or messages on the display surface, the modulation means being suitable for varying the angle of incidence of the light rays emitted by the light source.

According to particular characteristics, the filters comprise components suitable for achieving total or partial reflections according to the angle of incidence of the light rays and the light source comprises at least two electro-optical transducers suitable for illuminating said filters with different angles of incidence so as to reveal various symbols or messages on the display surface, the modulation means being suitable for varying the angle of incidence of the light rays emitted by the light source.

According to particular characteristics, the filters comprise components suitable for achieving different light transfers according to the angle of incidence of the light rays and the light source comprises at least two electro-optical transducers suitable for illuminating said filters with different angles of incidence so as to reveal various symbols or messages on the display surface, the modulation means being suitable for varying the angle of incidence of the light rays emitted by the light source.

By virtue of each of these arrangements, the various symbols or messages displayed alternately on the same display surface can exhibit the same colors.

According to particular characteristics, the optical path going from the light source to the display surface comprises at least one optical fiber.

By virtue of these arrangements, this optical path can be very slender, for example of a thickness of less than 10 microns.

According to particular characteristics, the optical path going from the light source to the display surface comprises a reflecting optical component.

According to particular characteristics, the display device as succinctly set forth above comprises a means for receiving signals arising from a keyboard whose keys comprise display surfaces, signals representative of the keyboard keys activated by the user, the reception means being suitable for assigning said signals the symbol displayed by the key activated by the user.

By virtue of these arrangements, the processing of the inputting of a symbol on a key of the keyboard takes account of the symbol which was actually displayed on this key.

According to particular characteristics one, at least, of said filters consists of an ink deposited on a support.

By virtue of these arrangements, the user can customize the messages displayed by the devices.

The present invention is also aimed at an electronic device possessing at least one of the following functions: a personal digital assistant, an organizer, a telephone, a games console, a portable computer, an Internet access terminal, an automatic teller machine, a dashboard, a watch, a remote control, a portable music player, a positioning system and an audiovisual signals receiver, an item of electronic, office or leisure equipment, a facsimile machine, a photocopier, a scanner, a reader of recorded media, a home automation installation, an electrodomestic appliance, an item of medical equipment, a measurement apparatus, an automated analysis device, an item of automobile equipment, a signboard, a switch, a games device, a decorative element, a lamp, an electrical button and a display panel, which electronic device comprises a display device as succinctly set forth above.

According to a second aspect, the present invention is aimed at a display method which comprises:
a step of turning off a light source of a device comprising:
   at least one filter termed “upstream” carrying a message to be displayed,
   at least one second filter carrying a message to be displayed,
   a partially reflecting element placed downstream of at least the upstream filter,
the light source being suitable for illuminating each said filter by backlighting and
a step of turning on said light source to reveal a message carried by an upstream filter.

The advantages, aims and characteristics of this method and this electronic device being similar to those of the display devices which are the subjects of the first aspect as succinctly set forth above, they are not recalled here.

The present invention is also aimed, according to a third aspect, at a display device which comprises at least one key comprising:
at least one filter termed “upstream” carrying a message to be displayed on said key,
a light source suitable for illuminating each said filter, by backlighting,
a partially reflecting element placed downstream of at least one said filter and
an interaction detection means suitable for providing a signal representative of the interaction between a user and said key,

in such a manner that, when the light source is turned off, the message carried by each upstream filter, masked by the partially reflecting element, is not visible and, when the light source is turned on, a message carried by an upstream filter is visible.

By virtue of these arrangements, to reveal on the key a message carried by an upstream filter, the light source is turned on. The device can thus constitute an electrical button, a push-button, a contactor or a keyboard, for example, whose message display is variable.

According to particular characteristics, the device as succinctly set forth above comprises a key management means suitable for managing the turning on of the light source and for assigning the signal provided by each detection means a meaning dependent on the display on the key with which the user interacts.

By virtue of these arrangements, the processing of the inputting of a symbol on a key takes account of the message which was actually displayed on this key.

According to particular characteristics, the device as succinctly set forth above comprises, for at least one key, at least one filter termed “downstream” integrated with the partially reflecting element or situated downstream of the partially reflecting element and carrying a message, each downstream filter being placed on an optical path followed by light rays arising from the light source, the messages carried by each upstream filter and each downstream filter overlapping, at least partially,

in such a manner that, when the light source is turned off, a message carried by a downstream filter is visible and, when the light source is turned on, a message carried by an upstream filter is visible.

By virtue of these arrangements, a message carried by a downstream filter appears by default, under ambient light, when the light source is turned off and, to reveal another message, carried by an upstream filter, the light source is turned on.

Moreover, since the messages overlap at least partially, each message displayed can occupy visually, for the user, the major part of the display surface of the key and, in any case, a footprint that overlaps, at least partially, the footprint of the other messages corresponding to the other filters.

According to particular characteristics, at least two of said filters are superimposed.

According to particular characteristics, at least two of said filters each consist of a set of filter elements, said filter elements being juxtaposed alternately.

According to particular characteristics, the device as succinctly set forth above comprises a plurality of keys and a means for managing keys that is suitable for individually managing the turning on of the light source of each said key.

According to particular characteristics, the means for managing keys is suitable for causing messages to be displayed on keys, said messages corresponding to functions immediately available as a function of the state of the device.

According to particular characteristics, the means for managing keys is suitable for causing messages to be displayed successively on keys, said messages corresponding to symbols to be input by the user by interaction with the key carrying said message.

According to particular characteristics, the key management means is suitable for causing messages to be displayed jointly on keys, said messages corresponding to symbols of one and the same word.

According to particular characteristics, the management means is suitable for causing messages to be displayed on keys, said messages corresponding to symbols that the user can input, as a function of the user's speed of input.

According to particular characteristics, the management means is suitable for causing messages to be displayed on keys, said messages corresponding to symbols that the user can input, as a function of the user's input error rate.

According to particular characteristics, the device as succinctly set forth above comprises, for at least one key, at least two upstream filters carrying different messages and possessing different optical characteristics and a means for modulating at least one optical characteristic of the light source, each of said upstream filters corresponding to a value of optical characteristic modulated by the modulation means.

Thus, an optical characteristic of the light source is modulated in order that this characteristic corresponds to the filter representing a message to be displayed. Several different messages can then be displayed by backlighting, by modulating a physical characteristic of the light source.

According to particular characteristics, the modulation means is suitable for varying the luminous spectral band which reaches said filters and said filters exhibit different spectral transparency bands.

By virtue of these arrangements, when the modulation means varies the spectral band of the light rays which reach the filters, the latter take different visual appearances, this having the effect of revealing different symbols or messages in the display surface of the key, for example on the keyboard key with which these filters are associated or on the display panel comprising these filters.

According to particular characteristics, the light source comprises a light-emitting diode whose spectral emission band varies as a function of the electrical characteristics of the feed signal which is applied to it and the modulation means is suitable for varying said electrical characteristics.

By virtue of these arrangements, the construction of the light source, of the optical system and of the modulation means are simplified.

According to particular characteristics, the light source comprises at least two electro-optical transducers, the modulation means being suitable for alternately controlling the emission of light by one or the other of the electro-optical transducers.

By virtue of these arrangements, the colors of the symbols or messages displayed alternately, can be identical, the switching of the electro-optical transducers causing their successive displays.

According to particular characteristics, the modulation means is suitable for varying a main polarization axis of the light rays reaching the filters and at least one filter exhibits a different transparency according to the polarization of the light which reaches it.

By virtue of these arrangements, the various symbols or messages displayed alternately on the same display surface can exhibit the same colors.

According to particular characteristics, the light source comprises a plurality of electro-optical transducers furnished with optical fibers whose outputs form a message on the key, the modulation means being suitable for causing light to be emitted by said electro-optical transducers.

By virtue of these arrangements, the keyboard can be very slender.

According to particular characteristics, at least one filter comprises a component suitable for achieving constructive or destructive interferences according to the angle of incidence of the light rays and the modulation means is suitable for varying the angle of incidence of the light rays emitted by the light source.

According to particular characteristics, at least one filter comprises at least one hologram and the light source comprises at least two electro-optical transducers suitable for illuminating said holograms with different angles of incidence, the modulation means being suitable for varying the angle of incidence of the light rays emitted by the light source.

According to particular characteristics, at least one filter comprises at least one component suitable for achieving different light transfers according to the angle of incidence of the light rays and the light source comprises at least two electro-optical transducers suitable for illuminating said filters with different angles of incidence, the modulation means being suitable for varying the angle of incidence of the light rays emitted by the light source.

By virtue of each of these arrangements, the various symbols or messages displayed alternately on the same display surface can exhibit the same colors.

According to particular characteristics, the optical path of the rays arising from the light source comprises at least one optical fiber.

By virtue of these arrangements, this optical path can be very slender, for example of a thickness of less than 10 microns.

According to particular characteristics, the optical path of the rays arising from the light source comprises a reflecting optical component.

According to particular characteristics, one, at least, of said filters consists of ink deposition deposited on a uniform support.

By virtue of these arrangements, the user can customize the messages displayed by the devices.

According to particular characteristics, for at least one key, the detection means is suitable for causing a change of the display on said key.

According to particular characteristics, the partially reflecting element comprises a frosted surface.

The present invention is also aimed at an electronic device possessing at least one of the following functions: a personal digital assistant, an organizer, a telephone, a games console, a computer, an Internet access terminal, an automatic teller machine, a dashboard, a watch, a remote control, a portable music player, a positioning system and an audiovisual signals receiver, an item of electronic, office or leisure equipment, a facsimile machine, a photocopier, a scanner, a reader of recorded media, a home automation installation, an electrodomestic appliance, an item of medical equipment, a measurement apparatus, an automated analysis device, an item of automobile equipment, a signboard, a switch, a games device, a decorative element, a lamp, an electrical button and a display panel, which electronic device comprises a display device as succinctly set forth above.

According to a fourth aspect, the present invention is aimed at a display method which comprises:
a step of turning on a light source of at least one key comprising:
   at least one filter termed “upstream” carrying a message to be displayed on said key, the light source being suitable for illuminating each said filter by backlighting,
   a partially reflecting element placed downstream of at least one said filter;

a message carried by an upstream filter then being visible,
a step of turning off said light source, the message carried by each upstream filter, masked by the partially reflecting element, then not being visible and
an interaction detection step so as to provide a signal representative of the interaction between a user and said key.

The advantages, aims and characteristics of this display method and of this electronic device being similar to those of the display device which is the subject of the third aspect as succinctly set forth above, are not recalled here.

All the essential, preferential or particular characteristics of the various aspects of the present invention can be combined to achieve other embodiments of the present invention exhibiting combinations of the advantages set forth above.

Other advantages, aims and characteristics of the present invention will emerge from the description which will follow given, for explanatory and wholly nonlimiting purposes, in conjunction with the appended drawings in which:

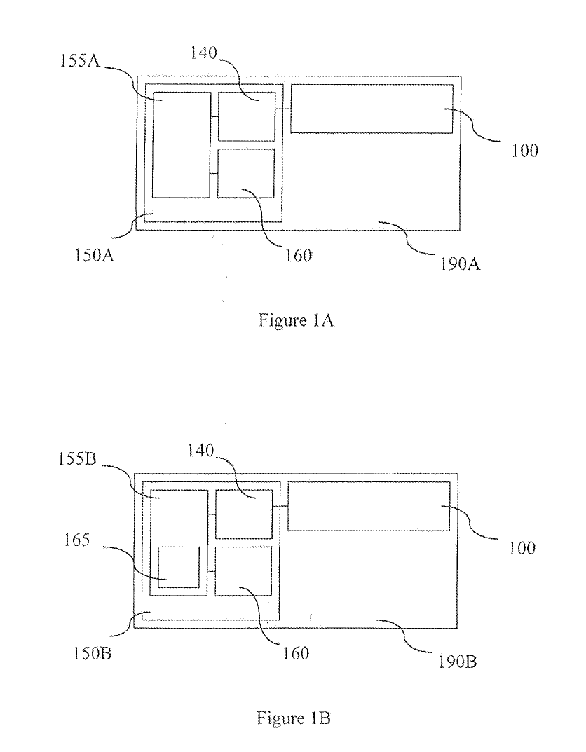

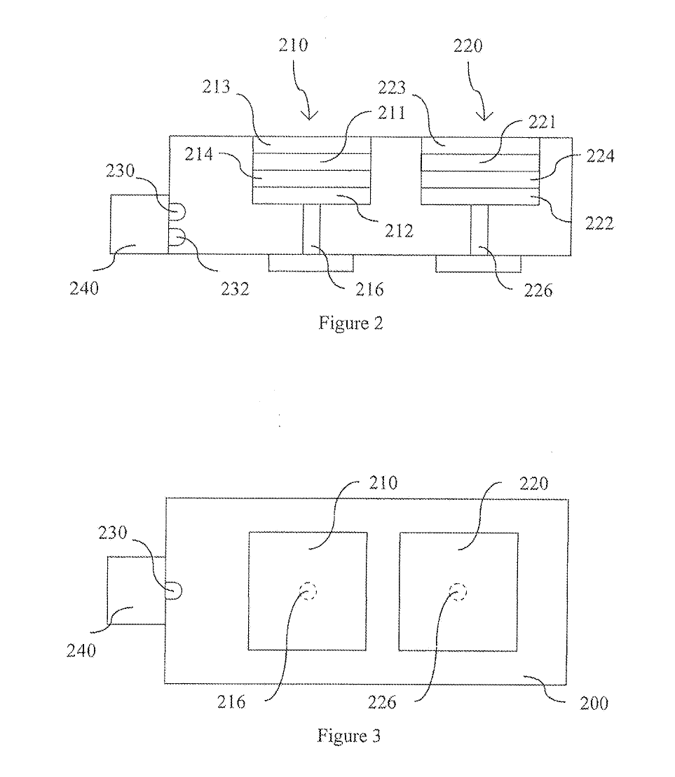

FIGS. 1A and 1B represent, schematically, two variants of an electronic circuit associated with a display device such as illustrated in one of FIGS. 2 to 14,

FIG. 2 represents, schematically, in section, a first embodiment of the display device which is the subject of the present invention,

FIG. 3 represents, schematically, viewed from above, the display device illustrated in FIG. 2,

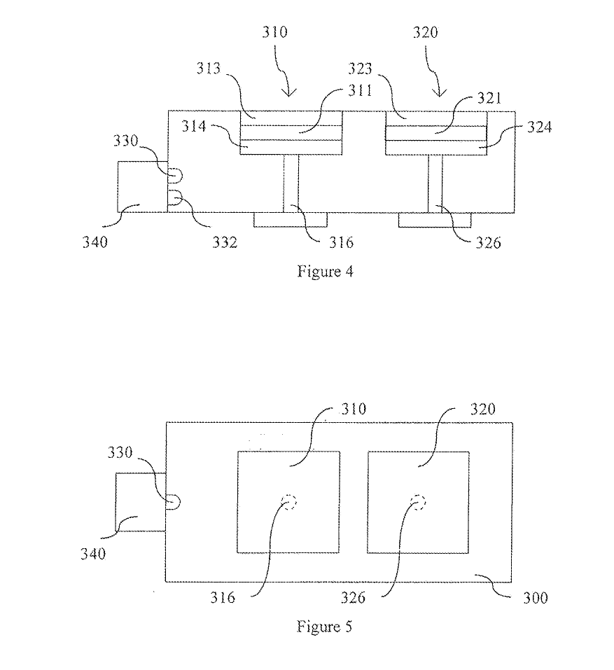

FIG. 4 represents, schematically, in section, a second embodiment of the display device which is the subject of the present invention,

FIG. 5 represents, schematically, viewed from above, the display device illustrated in FIG. 4,

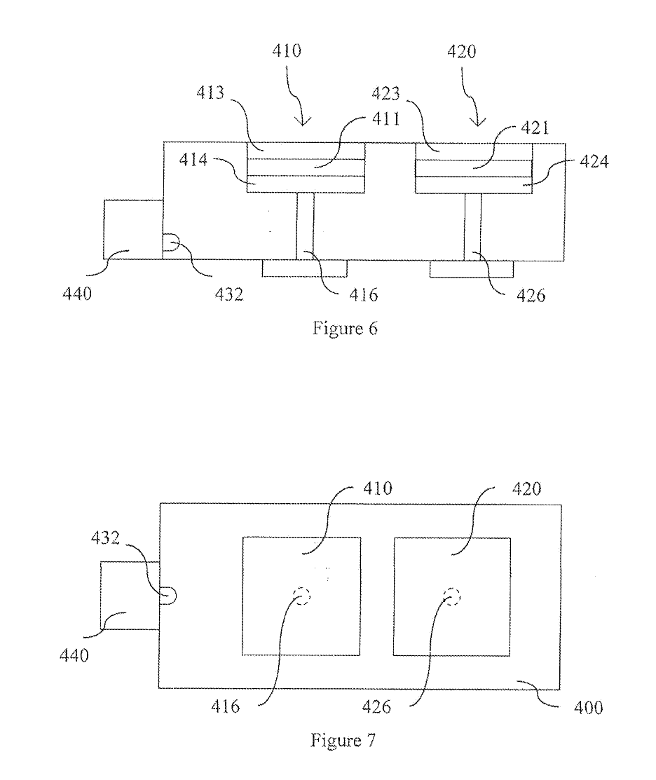

FIG. 6 represents, schematically, in section, a third embodiment of the display device which is the subject of the present invention,

FIG. 7 represents, schematically, viewed from above, the display device illustrated in FIG. 6,

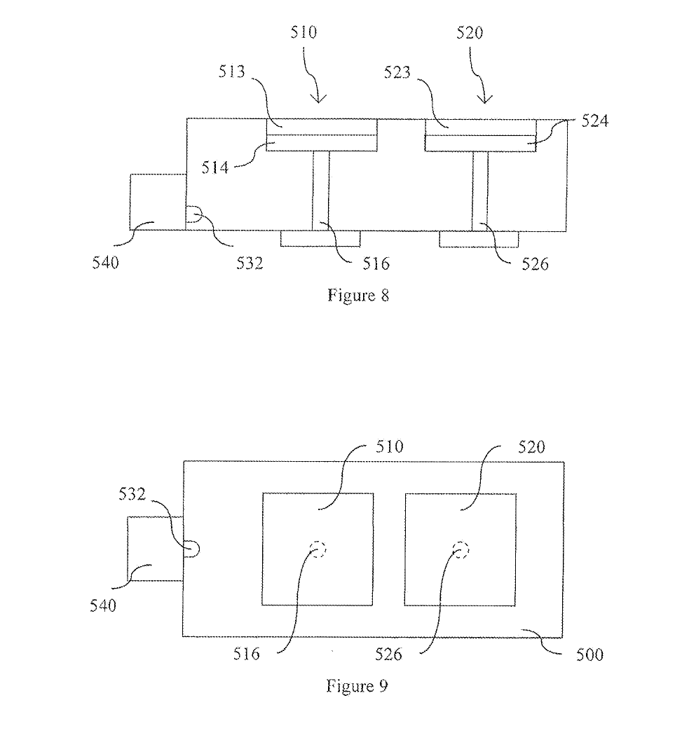

FIG. 8 represents schematically, in section, a fourth embodiment of the display device which is the subject of the present invention,

FIG. 9 represents, schematically, viewed from above, the display device illustrated in FIG. 8,

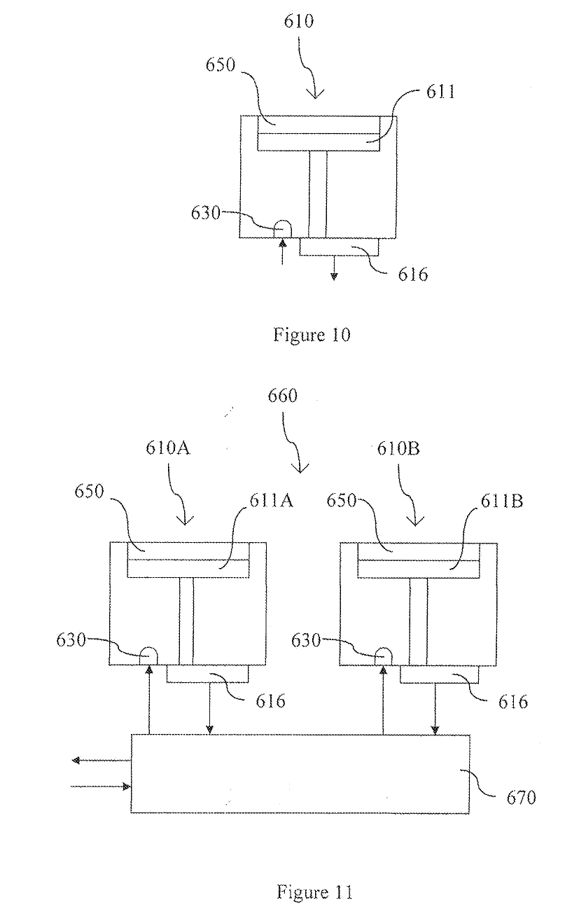

FIG. 10 represents, schematically, in section, a fifth embodiment of the display device which is the subject of the present invention,

FIG. 11 represents, schematically, in section, a sixth embodiment of the display device which is the subject of the present invention,

FIG. 12 represents, in the form of a logic diagram, steps implemented in a first particular embodiment of the method which is the subject of the present invention,

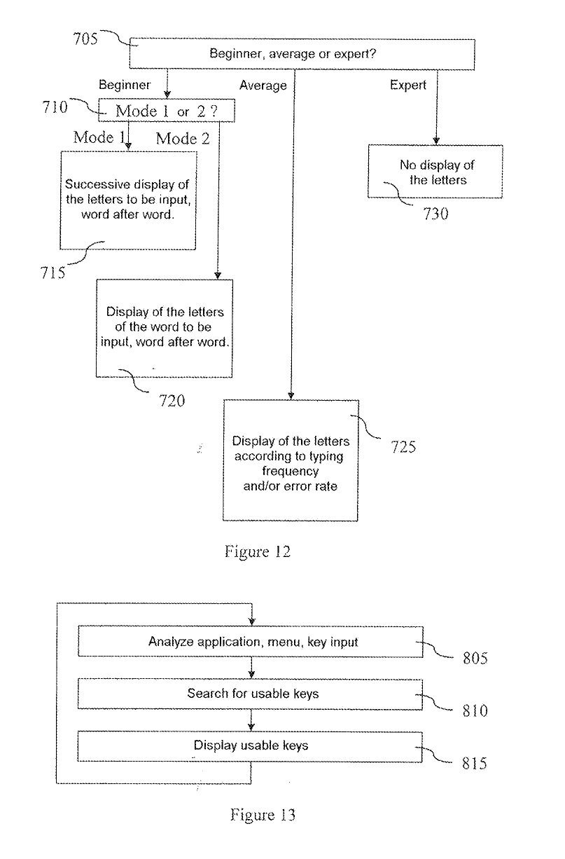

FIG. 13 represents, in the form of a logic diagram, steps implemented in a second particular embodiment of the method which is the subject of the present invention and

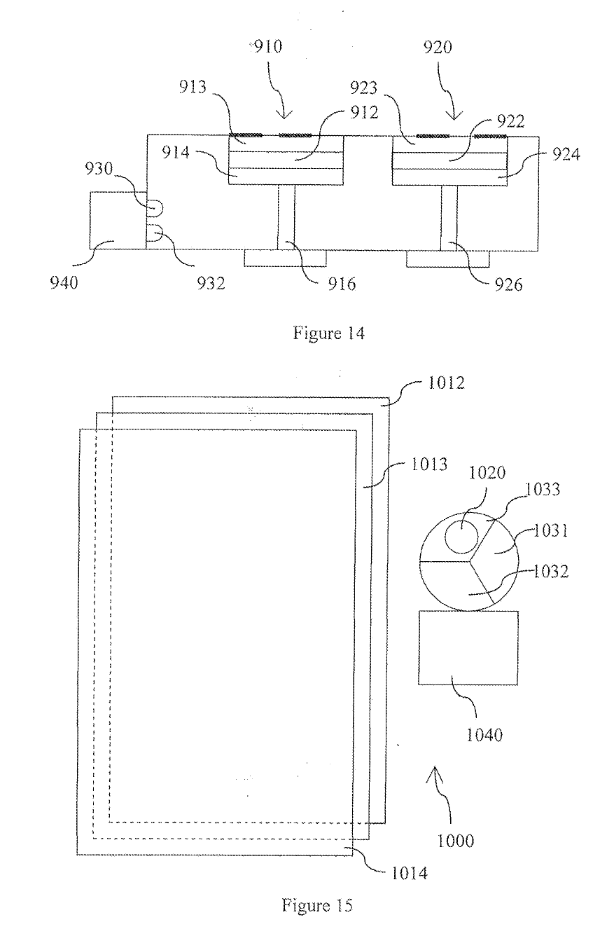

FIG. 14 represents, schematically, in section, a seventh embodiment of the display device which is the subject of the present invention,

FIG. 15 represents, schematically, an eighth embodiment of the display device which is the subject of the present invention, in the form of a panel suitable for displaying various messages,

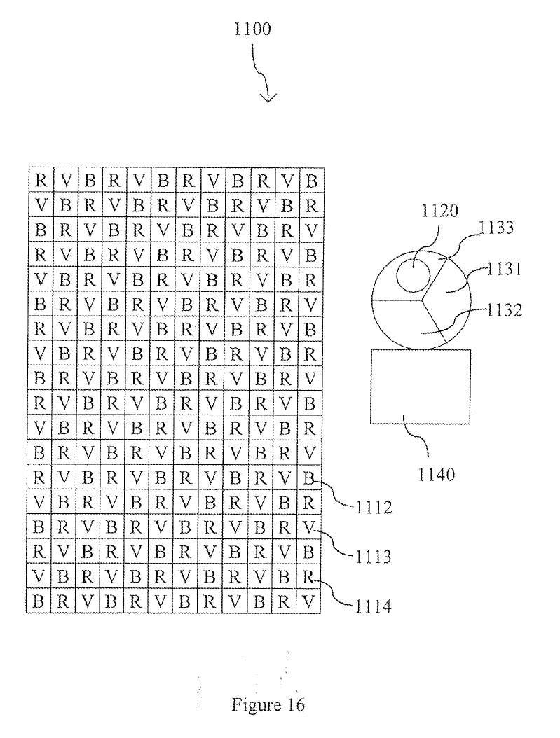

FIGS. 16 to 19 represent, schematically, in section, display surfaces of particular embodiments of a display for displaying various messages and

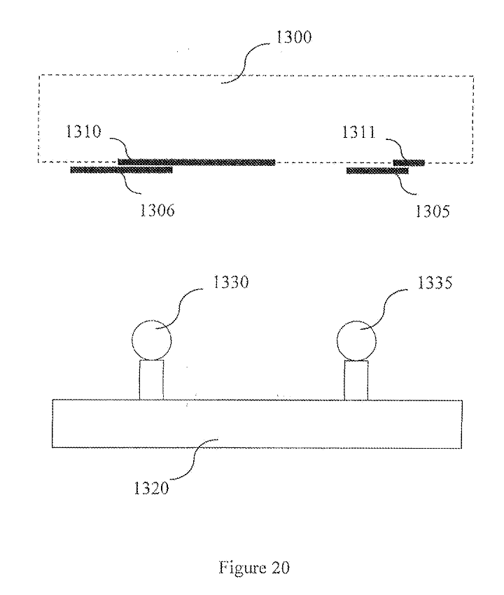

FIG. 20 represents, schematically and in section, a ninth embodiment of the display device which is the subject of the present invention.

Throughout the description, light sources comprising one or more light-emitting diodes are described. However, the present invention is not limited to this type of electro-optical transducer, but covers all types of light sources, for example organic light-emitting diode (or “oled”), incandescent bulb or so-called “fluo” bulb.

In FIGS. 2 to 14, keyboards comprising a plurality of keys are represented. The present invention is not limited to this type of keyboard but, quite to the contrary, extends to keyboards with a single key, to keys, buttons and contactors which implement the characteristics of the present invention.

Throughout the description of keys or keyboards, by way of example, interaction detection means are described in the form of electric contactors achieving electrical contact when the user presses a key linked to said contactor. However, the present invention can be implemented with all types of detection means, for example contactors implementing conducting rubbers, mechanical contactors, tactile or non-tactile membranes, contactors implementing optical switchings, variations in impedance, for example in capacitance, Hall-effect, Reed, PushGate and Piezoelectric contactors, or emitter-receivers of radiation, for example infrared, electrical or magnetic for detecting the pressing or proximity of a finger of the user.

In the description, numerous filters possessing at least one transparent part are described. However, to compensate for the luminous intensity differences which could appear between these transparent parts and the filtering parts, for the light rays which are not filtered there, the parts termed transparent, can have a transparency coefficient of less than 100%.

Throughout the description, “message” or “symbol” is used to designate an intelligible visible form. For example, letters, digits, characters, words, photographs, logos, icons or other graphics are, within the sense of the present invention, messages or symbols. It is accepted that a surface of uniform color is not a message or a symbol within the sense of the present invention.

Throughout the description, “upstream” refers to a filter which is situated, on the optical path of the rays arising from a light source internal to the device, before a partially reflecting element and “downstream” refers to a filter which coincides with this partially reflecting element or is situated after this partially reflecting element.

Partially reflecting element refers to a surface which returns to the side from which light originates, at least 15% and preferably, at least 30%, of the light originating from this side, perpendicularly to this surface.

In FIG. 1A is seen an electronic circuit 150A associated with a keyboard 100 in an electronic apparatus 190A. The electronic circuit 150A comprises a switching control means 155A and a means 160 for utilizing the messages or symbols selected at the keyboard 100 by interaction of a user.

In the embodiment illustrated in FIG. 1A, the switching control means 155A comprises two outputs, one of which controls the modulation means 140 of the keyboard 100 and the other of which is connected to the utilization means 160.

The switching control means 155A is a programmable system furnished with a program or a program routine, for example acting as a function of choices made by the user in the course of navigating around a functions and parameters menu, as a function of computer applications implemented by the apparatus 190A and/or of contextual factors as set forth further on.

In FIG. 1B is seen an electronic circuit 150B associated with a keyboard 100 in an electronic apparatus 190B. The electronic circuit 150B comprises a switching control means 155B and the means 160 for utilizing the messages or symbols selected at the keyboard 100 by interaction of a user.

In the embodiment illustrated in FIG. 1B, the switching control means 155B comprises a sensor of a physical quantity 165 and two outputs, one of which controls the modulation means 140 of the keyboard 100 and the other of which is connected to the utilization means 160.

The sensor of a physical quantity 165 is suitable for sensing a variation in at least one physical quantity, for example a press of a key, an optical masking, a position of the apparatus 190. It can therefore consist, for example, of at least one photodiode, of at least one phototransistor, of a manual switch, of a keyboard key, of an orientation sensor.

For example, the sensor 165 is a sensor of the presence of a hand of the user, so as to select the messages or symbols to be displayed as a function of the hand used to input a symbol at the keyboard.

The keyboard 100 complies with an embodiment of the keyboard which is the subject of the present invention, for example one of the embodiments set forth in conjunction with FIGS. 1 to 14.

The switching of the switching means causes a change of messages displayed on the keyboard 100 and a change of interpretation of the messages input with this keyboard with a view to their utilization by the utilization means 160.

For example, two sets of symbols represent two sets of letters of the alphabet whose switching is controlled by virtue of a photosensitive sensor which can be masked by a finger of the user.

According to another exemplary application, to achieve a universal remote control keyboard, the present invention makes it possible to assign the same keyboard keys successively to various interfaces to which the user has become accustomed (television, music deck, video recorder, reader of digital media, etc.).

As a variant, the electronic circuit 150A or 150B is furnished with an ambient brightness sensor (for example a photodiode exposed to ambient light) and controls the brightness of each light source as an increasing function of the ambient brightness.

The electronic circuit, 150A or 150B, is suitable for ensuring at least one function of the electronic apparatus, 190A or 190B, from among the following, by virtue of specific circuits (not represented) of the utilization means 160.
personal digital assistant (known by the name PDA),
organizer,
telephone, particularly mobile telephone,
terminal for accessing the Internet or another computer network,
games console,
computer, particularly portable computer,
automatic teller machine,
dashboard,
watch,
remote control,
portable music player,
positioning system, for example by reference to satellite signals,
audiovisual signals receiver, for example portable television, portable radio or car radio,
electronic, office or leisure equipment,
facsimile machine,
photocopier,
scanner,
reader of recorded media,
home automation installation,
electrodomestic appliance,
medical equipment,
measurement apparatus,
automated analysis device,
automobile equipment,
signboard,
switch,
games device,
decorative element,
lamp,
electrical button and
display panel.

Among the applications of the present invention may be cited the possibility that it enables a very small keyboard to be achieved, exhibiting three displays, one for the digits and the other two for each half of an alphabetic keyboard. It is also possible to cite a keyboard comprising a small display of the last characters input and a memory of the characters input making it possible to store texts so as thereafter to transfer them to computer and/or telephonic devices.

In FIGS. 2 and 3 is seen a keyboard 200 comprising keys 210 and 220, furnished with a partially reflecting element respectively 211, key 210, and 221, key 220, filters, respectively 212 to 214, key 210, and 222 to 224, key 220, and with electric contactors, respectively 216 and 226. A light source consists of two light-emitting diodes 230 and 232 controlled by a modulation means 240.

For the key 210, starting from the outside, at the top in FIG. 2, are situated successively the downstream filter 213, the partially reflecting element 211, the upstream filter 214 and the upstream filter 212. For the key 220, starting from the outside, at the top in FIG. 2, are situated successively the downstream filter 223, the partially reflecting element 221, the upstream filter 224 and the upstream filter 222.

The electric contactors 216 and 226 effect electrical contact between their terminals when the keys 210 and 220, respectively, are pressed. The modulation means 240 is an electric switch which feeds one or the other or neither of the light-emitting diodes 230 and 232.

The light-emitting diodes 230 and 232 emit in different, preferably disjoint, spectral bands. For example, the light-emitting diode 230 emits light rays whose lengths are situated between 400 and 500 nanometers and the light-emitting diode 232 emits light rays whose lengths are situated between 600 and 700 nanometers.

The filters 212 to 214, on the one hand, and 222 to 224, on the other hand, are superimposed, that is to say they are situated successively placed on the optical path of the light rays arising from the light-emitting diodes 230 and 232. On the filters 212 to 214 are formed different symbols, for example “1” “&” and “>”, the filters 212 to 214 being respectively transparent outside of the forms of these symbols. The filters 212 and 214 and possess, in the form of the symbols, absorption spectra corresponding respectively substantially to the emission spectra of the light-emitting diodes 230 and 232. The downstream filter 213 possesses, in the form of the symbol that it carries, an absorption spectrum included in the visible wavelengths which are emitted by neither of the light-emitting diodes 230 and 232, for example from 500 to 600 nanometers.

The optical assembly of the key 220 is similar to that of the key 210, except that the symbols carried by the filters 222 to 224, respectively “2”, “/” and “<”, are in negative, the absorption of wavelengths occurring outside of the form of the symbols and the transparency being achieved in the form of the symbols.

When the modulation means 240 does not turn on any of the light-emitting diodes, it is the ambient lighting which illuminates the downstream filter 213 and, through it, the partially reflecting element 211. If the color of the light reflected by the partially reflecting element is neutral, the symbol visible on the key 210 is therefore the symbol “&”, in magenta on a gray background. Likewise, the symbol visible on the key 220 is the symbol “/” in gray on a magenta background. Of course, if the color of the light reflected by the partially reflecting element is not neutral, the color of the background of the symbol appearing on the key 210 and the color of the symbol appearing on the key 220 will be different.

When the modulation means 240 turns on the light-emitting diode 230 and turns off the light-emitting diode 232, the light source emits light rays whose wavelengths lie between 400 and 500 nanometers. The light rays emitted by the light source pass through the upstream filter 212 outside of the symbol represented by this filter and are absorbed in this symbol since its absorption spectrum corresponds to the emission spectrum of the light-emitting diode 230. Then, the remaining rays pass through the filters upstream 214 then downstream 213 both in the form of the symbol carried by these filters and outside of these symbols since these filters are transparent in the emission spectrum of the light-emitting diode 230. For the key 210, the visible symbol is therefore the symbol carried by the upstream filter 212, here “1”, which appears black on a blue background.

In the same manner, for the key 220, the visible symbol is the symbol carried by the upstream filter 222, here “2”, which appears blue on a black background.

When the modulation means 240 turns on the light-emitting diode 232 and turns off the light-emitting diode 230, the light source emits light rays whose wavelengths lie between 600 and 700 nanometers. The light rays emitted by the light source pass through the upstream filter 212 both outside of the symbol represented by this filter and in this symbol since it is transparent to the rays of the emission spectrum of the light-emitting diode 232. Then, the rays are absorbed in the form of the symbol carried by the upstream filter 214 and pass through this filter outside of the form of this symbol since the absorption spectrum of the upstream filter 214 corresponds to the emission spectrum of the light-emitting diode 232. The light rays emitted by the light source pass through the downstream filter 213 both outside of the symbol represented by this filter and in this symbol since the downstream filter 213 is transparent to the rays of the emission spectrum of the light-emitting diode 232.

For the key 210, the visible symbol is therefore the symbol carried by the upstream filter 214, here “>”, which appears black on a red background.

In the same manner, for the key 220 the visible symbol is the symbol carried by the upstream filter 224, here “<”, which appears red on a black background.

Thus, by virtue of the implementation of the present invention, by modulating a physical characteristic of the light emitted by the light source, here the wavelength of the emitted rays, either one symbol, or another is revealed on each key of the keyboard 200, a third symbol being displayed, by default, when the light source is turned off.

As a variant of the first embodiment, illustrated in FIGS. 2 and 3, the downstream filters 213 and 223 are eliminated in such a manner that, when the light sources are turned off, the keys 210 and 220 seem uniform in color, for example gray.

As a variant of the first embodiment, illustrated in FIGS. 2 and 3, the light source comprises a light-emitting diode whose emission wavelength spectrum depends on at least one electrical characteristic of the signal which is applied to it, for example the voltage.

As a variant of the first embodiment, illustrated in FIGS. 2 and 3, the light source comprises two light-emitting diodes emitting in the same visible spectrum, each associated with a chromatic filter.

As a variant of the first embodiment, illustrated in FIGS. 2 and 3, the light source comprises a light-emitting diode followed by a dichroic polarizing filter placed optically after a liquid-crystal screen with a single cell and comprising only one input polarizing filter, the control of this liquid-crystal screen making it possible to vary the output polarization of the liquid-crystal screen and, thus, the color of the light rays arising from the light source.

It is observed here that the number of filters that can be superimposed and the number of corresponding light-emitting diodes are not limited to two but can be as much as the number of different spectral bands that the light source and the chromatic filters can have, for example ten, if disjoint spectral bands each cover a spectrum width of thirty nanometers and the filters possess an absorption spectrum corresponding to the possible emission spectra of the light source.

In FIGS. 4 and 5 is seen a keyboard 300 comprising keys 310 and 320, furnished with a partially reflecting element respectively 311, key 310, and 321, key 320, with filters, respectively 313 and 314, key 310, and 323 and 324, key 320, and with electric contactors, respectively 316 and 326. A light source consists of two light-emitting diodes 330 and 332 controlled by a modulation means 340.

For the key 310, starting from the outside, at the top in FIG. 4, are situated successively the downstream filter 313, the partially reflecting element 311 and the upstream filter 314. For the key 320, starting from the outside, at the top in FIG. 4, are situated successively the downstream filter 323, the partially reflecting element 321 and the upstream filter 324.

The electric contactors 316 and 326 effect electrical contact between their terminals when the keys 310 and 320, respectively, are pressed. The modulation means 340 is an electric switch which feeds one or the other or neither of the light-emitting diodes 330 and 332.

The light-emitting diodes 330 and 332 emit in different, preferably disjoint, spectral bands. For example, the light-emitting diode 330 emits light rays whose lengths are situated between 400 and 550 nanometers and the light-emitting diode 332 emits light rays whose lengths are situated between 550 and 700 nanometers.

The downstream 313 and upstream 314 filters, on the one hand, and the downstream 323 and upstream 324 filters, on the other hand, are superimposed, that is to say they are situated successively placed on the optical path of the light rays arising from the light-emitting diodes 330 and 332. On the downstream 313 and upstream 314 filters are formed different symbols, for example “1”, and “>”, the downstream 313 and upstream 314 filters being respectively transparent outside of the forms of these symbols and possessing, in the form of the symbols, absorption spectra corresponding respectively substantially to the emission spectra of the light-emitting diodes 330 and 332.

The optical assembly of the key 320 is similar to that of the key 310, except that the symbols carried by the downstream 323 and upstream 324 filters, respectively “2” and “<”, are in negative, the absorption of wavelengths occurring outside of the form of the symbols and the transparency being achieved in the form of the symbols.

When the modulation means 340 does not turn on any of the light-emitting diodes, it is the ambient lighting which illuminates the downstream filter 313 and, through it, the partially reflecting element 311. If the color of the light reflected by the partially reflecting element is neutral, the symbol visible on the key 310 is therefore the symbol “1”, in orangy red on a neutral background. Likewise, the symbol visible on the key 320 is the symbol “2” carried by the downstream filter 323, colored neutral (gray) on an orangy red background. Of course, if the color of the light reflected by the partially reflecting element is not neutral, the color of the background of the symbol appearing on the key 310 and the color of the symbol appearing on the key 320 will be different.

When the modulation means 340 turns on the light-emitting diode 330 and turns off the light-emitting diode 332, the light source emits light rays whose wavelengths lie between 400 and 550 nanometers. The light rays emitted by the light source pass through the upstream filter 314 since its absorption spectrum does not correspond to the emission spectrum of the light-emitting diode 330. Then, the remaining rays pass through the downstream filter 313 outside of the form of the symbol carried by this filter but not in the form of these symbols since these filters absorb, in the form of the symbols, the emission spectrum of the light-emitting diode 330. For the key 310, the visible symbol is therefore the symbol carried by the downstream filter 313, here “1”, which appears black on a blue-green background.

In the same manner, for the key 320, the visible symbol is the symbol carried by the downstream filter 323, here “2”, which appears blue-green on a black background.

When the modulation means 340 turns on the light-emitting diode 332 and turns off the light-emitting diode 330, the light source emits light rays whose wavelengths lie between 550 and 700 nanometers. The light rays emitted by the light source are absorbed in the form of the symbol carried by the upstream filter 314 and pass through this filter outside of the form of this symbol since the absorption spectrum of the upstream filter 314 corresponds to the emission spectrum of the light-emitting diode 332. The light rays emitted by the light source pass through the downstream filter 313 both outside of the symbol represented by this filter and in this symbol since it is transparent to the rays of the emission spectrum of the light-emitting diode 332.

For the key 310, the visible symbol is therefore the symbol carried by the upstream filter 314, here “>”, which appears black on an orangy background. In the same manner, for the key 320, the visible symbol is the symbol carried by the upstream filter 324, here “<”, which appears orangy on a black background.

Thus, by virtue of the implementation of the present invention, by modulating a physical characteristic of the light emitted by the light source, here the wavelength of the emitted rays, either one symbol, or another is revealed on each key of the keyboard 300, one of these symbols being displayed, by default, when the light source is turned off.

As a variant of the second embodiment, illustrated in FIGS. 4 and 5, the downstream filters 313 and 323 are eliminated and the light source is not modulated, apart from being turned on (display of the symbols carried by the upstream filters 314 and 324) and turned off (no symbol displayed on the keys).

As a variant of the second embodiment, illustrated in FIGS. 4 and 5, the light source comprises a light-emitting diode whose emission wavelength spectrum depends on at least one electrical characteristic of the signal which is applied to it, for example the voltage.

As a variant of the second embodiment, illustrated in FIGS. 4 and 5, the light source comprises two light-emitting diodes emitting in the same visible spectrum, each associated with a chromatic filter.

As a variant of the second embodiment, illustrated in FIGS. 4 and 5, the light source comprises a light-emitting diode followed by a dichroic polarizing filter placed optically after a liquid-crystal screen with a single cell and comprising only one input polarizing filter, the control of this liquid-crystal screen making it possible to vary the output polarization of the liquid-crystal screen and, thus, the color of the light rays arising from the light source.

It is observed here that the number of filters that can be superimposed and the number of corresponding light-emitting diodes are not limited to two but can be as much as the number of different spectral bands that the light source and the chromatic filters can have, for example ten, if disjoint spectral bands each cover a spectrum width of thirty nanometers and the filters possess an absorption spectrum corresponding to the possible emission spectra of the light source.

In FIGS. 6 and 7 is seen a keyboard 400 comprising keys 410 and 420 furnished with a partially reflecting element respectively 411, key 410, and 421, key 420, with filters, respectively downstream 413 and upstream 414, key 410, and downstream 423 and upstream 424 filters, key 420, and with electric contactors respectively 416 and 426. A light source consists of a light-emitting diode 432 controlled by a modulation means 440.

For the key 410, starting from the outside, at the top in FIG. 6, are situated successively the downstream filter 413, the partially reflecting element 411 and the upstream filter 414. For the key 420, starting from the outside, at the top in FIG. 6, are situated successively the downstream filter 423 the partially reflecting element 421 and the upstream filter 424.

The electric contactors 416 and 426 effect electrical contact between their terminals when the keys 410 and 420 respectively are pressed. The modulation means 440 is an electric switch which turns the light-emitting diode 432 on or off. The light-emitting diode 432 emits light rays whose lengths are situated between 550 and 700 nanometers.

The downstream 413 and upstream 414 filters on the one hand, and the downstream 423 and upstream 424 filters, on the other hand, are superimposed, that is to say they are situated successively placed on the optical path of the light rays arising from the light-emitting diode 432. On the downstream 413 and upstream 414 filters are formed different symbols, for example “1”, and “>”. The downstream 413 and upstream 414 filters are respectively transparent outside of the forms of these symbols and possessing, in the form of the symbols, absorption spectra corresponding respectively substantially to the emission spectrum of the light-emitting diode 432, upstream filter 414, and to the remainder of the visible spectrum, downstream filter 413.

The optical assembly of the key 420 is similar to that of the key 410, except that the symbols carried by the downstream 423 and upstream 424 filters, respectively “2” and “<”, are in negative, the absorption of wavelengths occurring outside of the form of the symbols and the transparency being achieved in the form of the symbols.

When the modulation means 440 does not turn on the light-emitting diode 432 it is the ambient lighting which illuminates the downstream filter 413 and, through it, the partially reflecting element 411. If the color of the light reflected by the partially reflecting element is neutral, the symbol visible on the key 410 is therefore the symbol “1” carried by the downstream filter 413, orangy red on a gray background. Likewise, the symbol visible on the key 420 is the symbol “2” carried by the downstream filter 423, gray on an orangy red background. Of course if the color of the light reflected by the partially reflecting element is not neutral, the color of the background of the symbol appearing on the key 310 and the color of the symbol appearing on the key 320 will be different.

When the modulation means 440 turns on the light-emitting diode 432 the light source emits light rays whose wavelengths lie between 550 and 700 nanometers. The light rays emitted by the light source are absorbed in the form of the symbol carried by the upstream filter 414 and pass through this filter outside of the form of this symbol since the absorption spectrum of the upstream filter 414 corresponds to the emission spectrum of the light-emitting diode 432. The light rays emitted by the light source pass through the downstream filter 413 both outside of the symbol represented by this filter and in this symbol since it is transparent to the rays of the emission spectrum of the light-emitting diode 432.

For the key 410 the visible symbol is therefore the symbol carried by the upstream filter 414, here “>”, which appears black on an orangy background.

In the same manner, for the key 420, the visible symbol is the symbol carried by the upstream filter 424 here “<”, which appears orangy on a black background.

In FIGS. 8 and 9 is seen a keyboard 500 comprising keys 510 and 520, furnished with filters, respectively downstream 513 and upstream 514, key 510, and downstream 523 and upstream 524 filters, key 520, and with electric contactors, respectively 516 and 526. A light source consists of a light-emitting diode 532 controlled by a modulation means 540.

For the key 510, starting from the outside, at the top in FIG. 8, are situated successively the downstream filter 513 which comprises a partially reflecting element and the upstream filter 514. For the key 520, starting from the outside, at the top in FIG. 8, are situated successively the downstream filter 523, which comprises a partially reflecting element 521, and the upstream filter 524.

The electric contactors 516 and 526 effect electrical contact between their terminals when the keys 510 and 520, respectively, are pressed. The modulation means 540 is an electric switch which turns the light-emitting diode 532 on or off. The light-emitting diode 532 emits light rays whose lengths are situated between 550 and 700 nanometers.

The downstream 513 and upstream 514 filters, on the one hand, and the downstream 523 and upstream 524 filters, on the other hand, are superimposed, that is to say they are situated successively placed on the optical path of the light rays arising from the light-emitting diode 532. On the downstream 513 and upstream 514 filters are formed different symbols, for example “1”, and “>”. The upstream filter 514 is transparent outside of the form of the symbol that it carries and possesses in the form of this symbol, an absorption spectrum corresponding to the emission spectrum of the light-emitting diode 532. The downstream filter 513 is partially reflecting outside of the form of the symbol that it carries and is transparent or gray in the form of this symbol. Preferably, the transparency of the downstream filter 513 is substantially uniform over its surface for the wavelengths emitted by the light-emitting diode 532.

The optical assembly of the key 520 is similar to that of the key 510, except that the symbols carried by the downstream 523 and upstream 524 filters, respectively “2” and “<”, are in negative: for the downstream filter 523, the reflecting part is in the symbol and, for the upstream filter 524, the absorption of wavelengths occurring outside of the form of the symbol and the transparency being achieved in the form of this symbol.

When the modulation means 540 does not turn on the light-emitting diode 532, it is the ambient lighting which illuminates the downstream filter 513 and is reflected outside of the form of the symbol. The symbol visible on the key 510 is therefore the symbol “1”, black on a gray background. Likewise, the symbol visible on the key 520 is the symbol “2” carried by the downstream filter 523, gray on a black background.

When the modulation means 540 turns on the light-emitting diode 532, the light source emits light rays whose wavelengths lie between 550 and 700 nanometers. The light rays emitted by the light source are absorbed in the form of the symbol carried by the upstream filter 514 and pass through this filter outside of the form of this symbol since the absorption spectrum of the upstream filter 514 corresponds to the emission spectrum of the light-emitting diode 532. The light rays emitted by the light source pass through the downstream filter 513 both outside of the symbol represented by this filter and in this symbol since the downstream filter 513 possesses is partially transparent or totally transparent to the rays of the emission spectrum of the light-emitting diode 532, over the whole of its surface. For the key 510, the visible symbol is therefore the symbol carried by the upstream filter 514, here “>”, which appears black on an orangy background. In the same manner, for the key 520, the visible symbol is the symbol carried by the upstream filter 524, here “<”, which appears orangy on a black background. When, as is preferable, the transparency of the downstream filters 513 and 523 is uniform over the whole of their surface, for the wavelengths emitted by the light-emitting diode 532, the forms of the symbols carried by these filters are totally invisible in the absence of ambient light.

It is readily understood that the number of filters situated below the downstream filter 513 (respectively 523) is not limited to one and is limited only by the number of possible switchings of the light source. For example the light source can comprise two light-emitting diodes and two corresponding filters can be positioned below the downstream filter 513 (respectively 523).

Thus, by virtue of the implementation of the present invention, by modulating a physical characteristic of the light emitted by the light source, here the wavelength of the emitted rays, either one symbol or another is revealed on each key of the keyboard 400 or 500, one of these symbols being displayed, by default, when the light source is turned off.

The partially reflecting elements illustrated in FIGS. 2 to 9 can consist of metallized films or frosted surfaces, for example.

The filters implemented in the various embodiments are preferably rejection filters obtained by printing techniques, possibly multi-color techniques, for example three-color or four-color.

In FIG. 10 is seen a display device consisting of a key 610 comprising a light source 630, an upstream filter 611 carrying a message, a partially reflecting element 650 and an electric contactor 616.

The light source 630 is, for example, a light-emitting diode. The upstream filter 611 consists, for example, of a transparent medium on which a message has been printed, black on a transparent background or transparent on a black background, for example a keyboard symbol or a function icon. The partially reflecting element is, for example, a frosted surface and/or a medium printed with a partially transparent metallic gray color ink.

The electric contactor 616 is similar to the electric contactors described above. It is suitable for detecting an interaction of a user with the key 610, by pressing the upper surface of this key, for example.

The display device 610 thus comprises a key comprising:
at least one upstream filter 611 carrying a message to be displayed on the key,
a light source 630 suitable for illuminating said filter, by backlighting,
a partially reflecting element 650 placed downstream of the upstream filter 611 and
an interaction detection means 616, suitable for providing a signal representative of the interaction between a user and said key,

in such a manner that, when the light source 630 is turned off, the message carried by the upstream filter 611, masked by the partially reflecting element 650, is not visible and, when the light source 630 is turned on, the message carried by the upstream filter 611 is visible.

Such a key 610 can have many applications, for example, in a dashboard of a vehicle, in an office machine or equipment control board, for example. In modes of use, according to the state of the system and/or the commands available at a given moment, the message carried by the upstream filter 611 is or is not displayed by turning on the light source 630. The user can then trigger a function associated with this message by interacting with said key.

The user then sees displayed only the messages corresponding to functions available at a given instant. He is then less distracted by other “unnecessary” displays and more effective in his action.

In modes of use, the interaction, for example pressing the key 610, causes a toggling of the visual state, by change of state of the light source 630 and of the function corresponding to the next press of this key.

The display on the key is then permanently consistent with key function and with the state of the system to be controlled and its potential state change that the user can control.

In FIG. 11 is seen a keyboard 660 comprising two keys 610A and 610B similar to the key 610 illustrated in FIG. 10 whose upstream filters 611A and 611B, respectively, carry different messages. The keyboard 660 also comprises a key management circuit 670.

In FIG. 11 only two keys have been represented but the number of keys is not limited and can, for example, be as much as the number of keys of a computer keyboard, i.e. more than a hundred keys carrying as many different messages, for example symbols.

The keys management circuit 670 is suitable for individually controlling the light sources 630 of all the keys and for receiving and processing all the signals originating from the contactors 616. It is observed that the keys management circuit 670 can be incorporated physically into a keyboard, for example in the form of a microcontroller furnished with an appropriate piece of software, or be implemented by a piece of software of an electronic system comprising a programmable circuit, such as one of those described in conjunction with FIG. 1.

In embodiments, the keyboard 660 is suitable for implementing software deploying the logic diagrams illustrated in FIGS. 12 and/or 13.

The logic diagram illustrated in FIG. 12 corresponds to a means for learning keyboard typing. For example, the keyboard implemented is a keyboard such as illustrated in FIG. 11, comprising the same number of keys as a normal computer keyboard, the upstream filters of the keys corresponding to the symbols carried by the keys of the corresponding computer keyboard. Thus, when all the light sources 630 are turned off, no message appears on the keys of the keyboard. On the other hand, when all the light sources 630 are turned on, all the messages or symbols appear on the keyboard, as for a back-illuminated keyboard.

In this embodiment, the keys management circuit 670 turns on various light sources 630 successively so as to help the user to memorize the position of the keys on a computer keyboard or to learn a foreign language.

In the course of a step 705, the level of the user is chosen, between the levels “beginner”, “average” or “expert”. This choice can be made by the user, for example by clicking on an icon representing the level in question. This choice can also be made by default, by repeating the last level used. Finally, this choice can be made automatically, as a function of the user's results (in terms of speed of input and/or rate of errors made), to pass to the higher level.

If the “beginner” level has been chosen, in the course of a step 710, the operating mode is chosen between a mode “1”, or “letter by letter” and a mode “2”, or “word by word”. This choice can be made by the user, by default or as a function of the user's results, to pass from mode “1” to mode “2”.

If mode “1” has been chosen, in the course of a step 715, the successive display is prompted, letter after letter, of the letters of words, forming, or not, intelligible words and/or sentences. For this purpose, the keys management means 670 turns on the light source 630 of a key comprising the filter carrying the symbol of this letter. Then, when the user has input this letter by pressing the key in question, the keys management means 670 turns off the light source that was previously on and turns on the light source corresponding to the second letter to be input and so on and so forth until the user stops the exercise or another level or mode is chosen.

If mode “2” has been chosen, in the course of a step 720, the joint display is prompted of all the letters of words, forming, or not, intelligible sentences. For this purpose, the keys management means 670 turns on the light source 630 of all the keys comprising the filter carrying the symbol of one of the letters to be displayed. Then, when the user has input all the letters, in order, by pressing the keys in question, the keys management means 670 turns off the light sources that were previously on and turns on the light sources corresponding to the letters of a second word to be input and so on and so forth until the user stops the exercise or another level is chosen.

As a variant of mode “2”, each time a letter is input by the user, in the right order, the keys management means turns off the corresponding light source.

As a variant of mode “2”, the user must input the same word a predetermined number of times or until his typing speed is greater than a predetermined speed and/or his error rate is less than a predetermined rate before the keys management means 670 turns off all the light sources, the user having to re-input the word in question before the keys management means 670 passes to the following word.

Preferably, in each of modes “1” and “2”, the words to be input are defined according to the increasing difficulty of the exercises.

When, in the course of step 705, the “average” level is chosen, in the course of a step 725, along with the inputting of a text, which can be free, displayed on a screen or dictated by way of a loudspeaker, the keys management means 670 varies the luminous intensity of all the light sources 630.

At the start of the exercise, the keys management means 670 causes the display of the symbols carried by all the keys of the keyboard by turning on all the light sources of the keys of the keyboard and, during input, beyond a predetermined typing frequency and/or below a predetermined error rate, the luminous intensity emitted by the light sources decreases, progressively or abruptly, so that the symbols carried by the filters of the keys disappear. If, thereafter, the typing speed passes below another predetermined speed and/or if the error rate passes above another predetermined error rate, the luminous intensity emitted by the light sources increases, progressively or abruptly.

When, in the course of step 705, the “expert” level is chosen, in the course of a step 730, all of the light sources 630 remain off.

Thus, progressively, the user learns the position of the symbols on a keyboard and then does not look at the keyboard when inputting these symbols.

In FIG. 13 is seen a step 805 of analyzing an application, menu and/or key input by the user. Then, in the course of a step 810, the usable symbols are searched for as a function of the active application, of the menu selected and or of the previous key or keys input by the user.

Then, in the course of a step 815, the keys management means causes, by turning on certain light sources 630 and turning off other light sources 630, the display of just the usable symbols.

Thus, the keys management means 630 is suitable for displaying solely the symbols which the user may need. For example, during a presentation with the “slideshow” function of the Microsoft PowerPoint (registered trademarks) software, only the up and down arrow symbols are displayed.

According to another example, when the user has input one of the symbols “Ctrl”, “Fn”, “Alt Gr” or “Alt”, only the keys whose filters carry symbols that can follow these symbols “Ctrl”, “Fn”, “Alt Gr” or “Alt” are displayed. The user is thus helped to use the shortcuts and the secondary functions. Likewise, when a menu has been selected, for example with a pointing device, for example a mouse, the only symbols displayed are the symbols of the letters underlined in said menu, which letters correspond to shortcuts.

Then, as soon as the user has input a symbol by using the keyboard or a pointing device, step 805 is returned to.

By virtue of the implementation of this embodiment, illustrated in FIG. 13, of the method which is the subject of the present invention, the display of the symbols of the keyboard is permanently consistent with the state of the system to be controlled and its potential changes of state that the user can control.

It is observed that, when at least some of the keys of the keyboard make it possible to display two different messages that are not blank, be these two messages carried by two upstream filters or an upstream filter and a downstream filter, these messages corresponding to the multiple symbols carried by the keys of a standard keyboard, the keys management means is suitable for causing the display of just the symbols which correspond to the state of the system. For example, uppercase or lowercase letters are displayed according to the characters that can be input as a function of the use of the “Shift” and caps lock keys. Likewise, letters with accents or digits are displayed only when they can be input. The symbols of the function keys are displayed only when the “Fn” key has been activated.

As a variant, when a language is used by the user and symbols are not used in this language, they are not displayed.

As a variant, the user chooses whether his keyboard will operate in “azerty” mode or in “qwerty” mode.

In the seventh embodiment of the device which is the subject of the present invention, illustrated in FIG. 14, a downstream filter consists of two parts whose reflection capacities in ambient light are different, for example, a reflective mirror (or bright) part and another absorbent gray (or matt) part which, under backlighting, have substantially the same appearance. Thus, it is possible to obtain a plurality of different displayed messages, one of which is displayed under ambient light, without disturbing the viewing of the other messages to be displayed.

In this embodiment, the downstream filter incorporates a partially reflecting element (bright gray) on which a message is written in an almost unreflecting or absorbent manner (matt gray). Under ambient light, the contrast formed by these two parts renders the message carried by the downstream filter visible. On the other hand, during backlighting, these two parts offer substantially the same light transmissions and thus allow the display of one or more other messages.

When the ambient light is not sufficient, for example in darkness, a low luminous intensity of backlighting makes it possible to render visible the message carried on the downstream filter. This backlighting can be due to the light source set forth in the other embodiments or to an additional light source, preferably neutral with respect to each upstream filter.

For example, it is possible to obtain, on the same display surface, for example on a key:
a first message appearing by default without backlighting,
the same first message with backlighting with a backlighting consisting of a combination of the lights emitted by two light sources,
a second message under backlighting by one of the two light sources and
a third message under backlighting by the other of the two light sources.

In FIG. 14 is seen a keyboard 900 comprising keys 910 and 920, furnished with a downstream filter and partially reflecting element respectively 913, key 910, and 923, key 920, carrying messages, with filters, respectively 912 and 914, key 910, and 923 and 924, key 920, and with electric contactors, respectively 916 and 926. A light source consists of two light-emitting diodes 930 and 932 controlled by a modulation means 940.

The downstream filters 913 and 923 are of uniform color but of heterogeneous surface appearances. For example, the parts indicated in bold on the outside surface of the downstream filters 913 and 923 is matt, while the remainder of this surface is bright.

The light-emitting diodes emit in different, preferably disjoint, spectral bands. For example, the light-emitting diode 930 emits light rays whose lengths are situated between 400 and 550 nanometers and the light-emitting diode 932 emits light rays whose lengths are situated between 550 and 700 nanometers.

When the modulation means 940 does not turn on any of the light-emitting diodes, it is the ambient lighting which illuminates the downstream filter and partially reflecting element 913 and reveals the message carried by the heterogeneity of its surface.

When the modulation means 940 turns on the light-emitting diodes 930 and 932 with a low luminous intensity, it is this backlighting which illuminates the downstream filter and partially reflecting element 913 and reveals the message carried by the heterogeneity of its surface.

When the modulation means 940 turns on the light-emitting diode 930 and turns off the light-emitting diode 932, for the key 910, the visible symbol is the symbol carried by the upstream filter 912, as set forth in conjunction with other figures.

When the modulation means 940 turns on the light-emitting diode 932 and turns off the light-emitting diode 930, for the key 910, the visible symbol is the symbol carried by the upstream filter 914, as set forth in conjunction with other figures.

Thus, by virtue of the implementation of the present invention, by modulating a physical characteristic of the light emitted by the light source, here the wavelength of the emitted rays, either one symbol or another is revealed on each key of the keyboard 900, one of these symbols being displayed, by default, when the light source is turned off.

As a variant of the second embodiment, illustrated in FIG. 14, the upstream filter 912 is eliminated and the light source is not modulated in spectral ranges.

FIG. 15 represents, schematically, a display which is the subject of the present invention for displaying various messages, for example advertising, road signs, artistic messages, public transport timetables.

In the embodiment of this display, use is made of chromatic filters each carrying a message to be displayed and, in order to reveal a given message, the spectral emission band of a light source is modulated.

In FIG. 15 is seen a display panel 1000 comprising filters/displays 1012, 1013 and 1014. A light source consists of a white light source 1020 associated with a carrousel carrying three chromatic filters 1031, 1032 and 1033, set in motion by a motor controlled by a modulation means 1040 so that one or the other of the filters is situated opposite the light source 1020.

The chromatic filters 1031, 1032 and 1033 are suitable for allowing through the light in three different, preferentially disjoint, spectral bands. For example, the filter 1031 is transparent to the light rays whose lengths are situated between 400 and 500 nanometers, the filter 1032 is transparent to the light rays whose lengths are situated between 500 and 600 nanometers and the filter 1033 is transparent to the light rays whose lengths are situated between 600 and 700 nanometers.

The displays 1012 to 1014, which constitute filters, possibly diffusing, are superimposed, that is to say they are situated successively placed on the optical path of the light rays arising from the light source 1020. The displays 1012 to 1014 each carry a message, these messages being, possibly, combined, that is to say their construction is coordinated so that at least two messages carried by two displays form a new message.

The displays 1012 to 1014 are respectively transparent outside of the messages and possess, in the form of the messages, absorption spectra corresponding respectively substantially to the three transparency spectra of the filters 1031, 1032 and 1033.

When the modulation means 1040 causes the positioning of the filter 1031 in front of the white light source 1020, the light source emits light rays whose wavelengths lie between 400 and 500 nanometers. The light rays emitted by the light source pass through the display 1012 outside of the message represented by this filter and are absorbed in this message since its absorption spectrum corresponds to the lighting spectrum. Then, the remaining rays pass through the displays 1013 and 1014 both in the form of the message carried by these displays and outside of these messages since these displays are transparent in the lighting spectrum. The displayed message is therefore that carried by the display 1012, which appears black on a blue background.

When the modulation means 1040 causes the positioning of the filter 1032 in front of the white light source 1020, the light source emits light rays whose wavelengths lie between 500 and 600 nanometers. The light rays pass through the display 1012, both in the form of the message carried by this display and outside of this message since this display is transparent in the lighting spectrum.

Thereafter, the light rays pass through the display 1013 outside of the message represented by this display and are absorbed in this message since its absorption spectrum corresponds to the lighting spectrum. Then, the remaining rays pass through the display 1014 both in the form of the message carried by this display and outside of this message since this display is transparent in the lighting spectrum. The visible message is therefore the message carried by the display 1013, which appears black on a green background.

When the modulation means 1040 causes the positioning of the filter 1033 in front of the white light source 1020, the light source emits light rays whose wavelengths lie between 600 and 700 nanometers.

The light rays emitted by the light source pass through the displays 1012 and 1013 both in the form of the message carried by these displays and outside of these messages since these displays are transparent in the lighting spectrum.

Thereafter, the light rays pass through the display 1014 outside of the message represented by this display and are absorbed in this message since its absorption spectrum corresponds to the lighting spectrum.

The visible message is therefore the message carried by the display 1014 which appears black on a red background.

FIG. 16 schematically represents a display which is the subject of the present invention for displaying various messages, for example advertising, road signs, artistic messages, public transport timetables.

In the embodiment of this display, use is made of chromatic filters each carrying a message to be displayed and, in order to reveal a given message, the spectral emission band of a light source is modulated.

In FIG. 16 is seen a display panel 1100 comprising sets of filters, here square, juxtaposed and alternating 1112, 1113 and 1114. A light source consists of a white light source 1120 associated with a carrousel carrying three chromatic filters 1131, 1132 and 1133, set in motion by a motor controlled by a modulation means 1140 so that one or the other of the filters 1131, 1132 and 1133 is situated opposite the light source 1120.

The chromatic filters 1131, 1132 and 1133 are suitable for allowing through the light in three different, preferably disjoint, spectral bands. For example, the filter 1131 is transparent to the light rays whose lengths are situated between 400 and 500 nanometers, the filter 1132 is transparent to the light rays whose lengths are situated between 500 and 600 nanometers and the filter 1133 is transparent to the light rays whose lengths are situated between 600 and 700 nanometers.

The sets of filters or displays 1112 to 1114 each carry a message, these messages being, possibly, combined, that is to say their construction is coordinated so that at least two messages carried by two sets of filters or displays form a new message.

The filter sets 1112 to 1114 are respectively absorbent outside of the messages and possess, in the form of the messages, transmission spectra corresponding respectively substantially to the three transparency spectra of the filters 1131, 1132 and 1133.

It is understood that, according to the filter 1131, 1132 or 1133 which is situated in front of the light source 1120, the visible messages are those carried by the filter sets 1112, 1113 or 1114 respectively.

As a variant, at least two light sources are implemented to create animation effects of what appears displayed, for example cross-fading or progressive transition, of a point or side to the whole of the display surface between the messages that may be displayed. As variants, the messages are combined, at least two messages carried by two alternately juxtaposed filter sets being associated, for example in a two-color advertising message. The use of two light sources then makes it possible to reveal the various colors of the same message successively so as to attract attention.

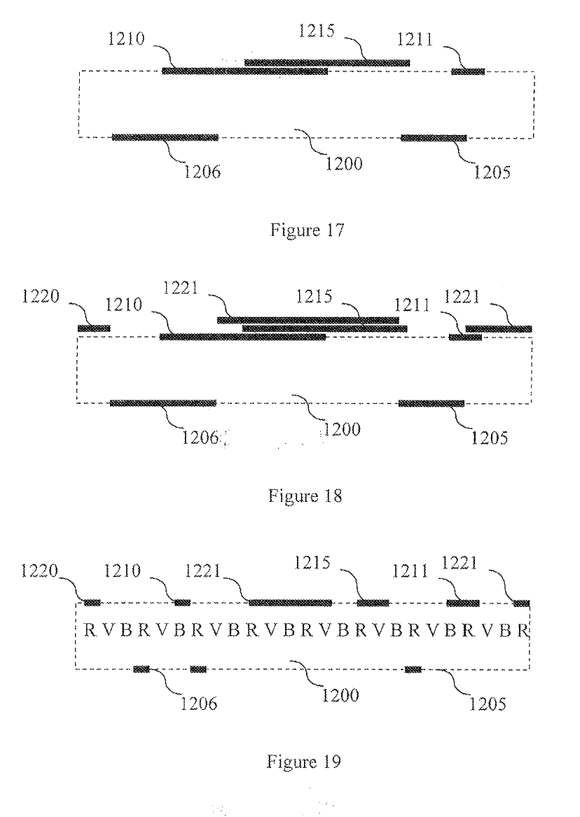

In FIGS. 17 to 19 is seen a display printed on each face with different colors on the various faces representing various symbols or messages or message elements that are coordinated. These are not to scale and only a small part of the display is represented, in cross section, in the form of a dashed rectangle 1200. The thick black dashes represent the various zones that have received ink. It has been assumed, here, that only three spectral ranges were used, for example:
a spectral range around red, on the front face of each of the displays (at the bottom of each of the figures) and, possibly also on the back face (FIGS. 18 and 19) and
two spectral ranges, respectively around green and around blue, on the back face of each of the displays (at the top in each of the figures).

In FIG. 17, the inks are superimposed on the back face. The zones that have received red ink are referenced 1205 and 1206. The zones that have received green ink are referenced 1210 and 1211 and the zone that has received blue ink is referenced 1215. It is understood that these zones are independent and can represent symbols or independent or coordinated messages.

FIG. 18 repeats the same elements as FIG. 17, to which are added, on the back face, zones 1220 and 1221, inked in red, with the same ink as the zones 1205 and 1206 but forming their complement in such a manner that for each part of the display which is inked in red on the front face, it is not inked in red on the back face, and vice versa.

In FIG. 19, the inks exhibit the same symbols and messages as in FIG. 18, with the same colors, but they are not superimposed, thus forming alternately juxtaposed filters.

In ambient light, when the backlighting light source is turned off, only what is printed on the front face is visible. At night, when the backlighting light source is turned on and emits, on at least a part of the display, the colors corresponding to two of the spectral ranges, only the message corresponding to the third spectral range is visible. At night, when the backlighting light source is turned on and emits, on at least a part of the display, the colors corresponding to only one of the spectral ranges, only the messages corresponding to the other spectral ranges are visible.

As regards the embodiments illustrated in FIGS. 18 and 19, a backlighting with a white light causes the message carried by the red colored ink to disappear since all the parts of the display carry a layer of red colored ink either on the front face or on the back face and the messages carried by the other two colors appear.

It is observed that the use of the front face to display a message or symbol when the light source is turned off is not limited to displays but can be implemented both in displays and in push-buttons, in keyboards or in the other applications of the present invention that are detailed in the description.

As a variant of the embodiments illustrated in FIG. 15 or 16, the light source comprises three lamps emitting in three visible spectra or are each associated with a chromatic filter.

It is observed here that the number of filter sets/displays that can be juxtaposed and the number of corresponding emission spectra are not limited to three but can be as much as the number of different spectral bands that the light source and the chromatic filters can have, for example ten, if disjoint spectral bands each cover a spectrum width of thirty nanometers and the filters/displays possess an absorption spectrum corresponding to the possible emission spectra of the light source.

It is observed that a cross-fade can be performed between the messages carried by the displays, by progressively reducing the luminous intensity emitted in one spectral band and by progressively increasing the luminous intensity emitted in another spectral band or by independently controlling the luminous intensities in the various spectral emission bands.

It is also possible to achieve animation effects, by sequencing the light sources implemented in conjunction with the various parts of the displays. The same principle can be implemented in toys or gadgetry articles, for example pens with an animated image depending on the luminous source or sources which are turned on.

In FIG. 20 is seen a display 1300 printed on its upstream face, the material of the display forming partially reflecting element. The printing of the various messages is done with different colors. This is not to scale and only a small part of the display is represented, in cross section, in the form of a dashed rectangle 1300. The thick black dashes represent the various zones that have received ink. It has been assumed, here, that only two spectral ranges were used, for example two spectral ranges, respectively around green and around blue, on the back face of each of the displays (at the top in each of the figures).

In FIG. 20, the inks are superimposed on the back face. The zones that have received red ink are referenced 1305 and 1306. The zones that have received green ink are referenced 1310 and 1311. It is understood that these zones are independent and can represent independent or coordinated symbols or messages.

The display 1300 is illuminated by backlighting by two light sources 1330 and 1335 that are turned on and controlled in spectral ranges emitted independently of one another, by a control circuit 1320. In variants, an optical partition can separate the various zones of the display 1300 which must be illuminated by various light sources.

In ambient light, when each backlighting light source is turned off, the display seems to be uniform in color. At night, when the backlighting light source is turned on and emits, on at least a part of the display, a more intense light than the ambient light, whose colors correspond to only one of the spectral ranges, only the messages corresponding to the other spectral ranges are visible. By varying the spectral ranges of the light sources, zone by zone or globally, the control circuit 1320 varies the messages which appear on the surface of the display.

It is observed that the display in question can be an arbitrary display not specifically designed to be incorporated into this embodiment of the device which is the subject of the present invention, the management, zone by zone or globally, of the luminous intensities and of the spectral ranges emitted making it possible to animate the display by successively revealing parts of the message displayed, so as to accentuate the effect thereof and/or to attract attention.

All the essential, preferential or particular characteristics of the various embodiments described above and/or represented in the figures can be combined to achieve other embodiments of the present invention.

As is seen, in each of the keyboard embodiments, the switching of the operating mode of a device and the switching of the symbols displayed occur in a coordinated manner, preferably simultaneously, under the command of a control means, as set forth in conjunction with FIG. 1. When a symbol is input by the user, the symbol displayed on the keyboard key used is the symbol taken into account by the computer application implemented by the device.

Diverse embodiment variants in accordance with the present invention are set forth below. For more information, the reader may read international application PCT FR 0500297 filed on 10 Feb. 2005 in the name of M. David Luo. This international application is incorporated here by reference in its entirety.

In a first variant, use is made of polarizing filters on which are formed various messages and, to reveal a given symbol, the principal direction of polarization of emission of a light source is modulated.

As a second variant, use is made of diopters which form image elements of various messages and, to reveal a given symbol, the direction of origin of the light rays of the light source is modulated. For example, the diopter sets consist of arrays of oriented scratches.

As a third variant, use is made of multi-layer treatments which, according to the wavelength of the incident light, are either very reflecting, or hardly reflecting and which are applied to image elements of various messages. To reveal a given message, the wavelength of the light rays emitted by the light source is modulated.

As a fourth variant, use is made of photoluminescent compounds forming various messages and, to reveal a given message, the spectral emission band of a light source is modulated. It is recalled here that a photoluminescent compound is a chemical compound which exhibits the particular feature of emitting light in a first spectrum (here a visible spectrum) when it is illuminated by light in a second spectrum (here an infrared and/or visible light spectrum).

As a fifth variant, use is made of holographic images of various messages, which images appear when the direction of the incident rays corresponds to their reference angle. To reveal a given message, the direction of origin of the light rays of the light source is modulated so as to make this direction match one of those which serve as reference for the formation of the holograms.

As a sixth variant, use is made of alternately juxtaposed filter sets, that is to say between two filters of a first set is situated a filter of the second set, and vice versa and that these filter sets are situated, optically, in parallel on the optical paths of the light rays arising from the light sources. A different message is formed on each of the filter sets.

As a seventh variant, use is made of polarizing filter sets possessing, in the same set, the same polarization axis and a polarization axis perpendicular to the other set of polarizing filters. Various messages are formed on these polarizing filter sets and, to reveal a given message, the principal direction of polarization of emission of a light source is modulated. It is observed that, to form symbols on polarizing filters, it is possible to take polarizing filters and to locally destroy their polarization capacity.

As an eighth variant, use is made of parallel optical conductors (for example optical fibers) partially frosted to form various messages and, to reveal a given message, light is emitted in one or the other of the optical conductors.

It is observed that, to implement the present invention, it is possible to split a keyboard into several sets of keys, each set of keys implementing one of the embodiments of the present invention, for example one of the embodiments presented above, in particular when the number of messages varies according to the keys of the keyboard.

It is also observed that the messages to be displayed can be provided for during the construction of the keyboard or, in particular embodiments, these messages can be achieved à posteriori, on blank and writable media, for example consisting of at least one filter layer sensitive to a physical quantity, for example heat, for example provided by a laser ray whose generator takes the form of a pen.

For all the embodiments set forth above incorporating filters which absorb light rays of certain wavelengths, these filters can be interferential filters in which layers of different optical index materials are superimposed, or, preferably, for reasons of ease of production, gelatins, transparent or translucent media on which patterns, symbols or messages are printed with color inks or marked with a marker delivering a colored ink or a color chalk.

1-17. (canceled)

18. A display device which comprises:
at least one filter termed “upstream” carrying a message to be displayed,
at least one second filter carrying a message to be displayed that is different from the message carried by each upstream filter,
a light source suitable for illuminating each said filter, by backlighting,
a partially reflecting element placed downstream of at least the upstream filter in such a manner that, when the light source is turned off, the message carried by each upstream filter, masked by the partially reflecting element, is not visible and, when the light source is turned on, a message carried by an upstream filter is visible.

19. The display device as claimed in claim 18, characterized in that the partially reflecting element is integrated into the second filter or placed upstream of the second filter in such a manner that, when the light source is turned off, the message carried by the second filter is visible and, when the light source is turned on, a message carried by an upstream filter is visible.

20. The device as claimed in claim 19, characterized in that the partially reflecting element is integrated into the second filter, the contour of the message to be displayed being defined by the contour of a partially reflecting zone integrated with said second filter.

21. The device as claimed in claim 18, characterized in that at least two of said filters are superimposed in the display surface.

22. The device as claimed in claim 18, characterized in that at least two of said filters consist, each of a set of filters, said filter sets being juxtaposed alternately in the display surface.

23. The device as claimed in claim 18, characterized in that it comprises at least one contactor suitable for providing a signal representative of the interaction between a user and at least one part of the display surface.

24. The device as claimed in claim 23, characterized in that it comprises a plurality of keys comprising a said contactor.

25. The display device as claimed in claim 18, characterized in that it comprises a means for modulating at least one physical characteristic of said light source, at least two filters, each corresponding to a value of physical characteristic modulated by the modulation means and to a message to be displayed on said display surface.

26. The device as claimed in claim 25, characterized in that the modulation means is suitable for varying the luminous spectral band which reaches said filters and said filters exhibit different spectral transparency bands.

27. The display device as claimed in claim 25, characterized in that the light source comprises at least two independent electro-optical transducers placed in parallel on an optical path of light rays originating from the light source and reaching the display surface, the modulation means being suitable for alternately controlling the emission of light by one or the other of the electro-optical transducers.

28. The display device as claimed in claim 25, characterized in that the modulation means is suitable for varying a main polarization axis of the light rays reaching the filters and the filters exhibit different transparencies according to the polarization axes.

29. The display device as claimed in claim 25, characterized in that the filters comprise holograms and the light source comprises at least two electro-optical transducers suitable for illuminating said holograms with different angles of incidence so as to reveal various symbols or messages on the display surface, the modulation means being suitable for varying the angle of incidence of the light rays emitted by the light source.

30. The display device as claimed in claim 18, characterized in that it comprises a means for receiving signals arising from a keyboard whose keys comprise display surfaces, signals representative of the keyboard keys activated by the user, the reception means being suitable for assigning said signals the symbol displayed by the key activated by the user.

31. The device as claimed in claim 18, characterized in that at least one of said filters consists of an ink deposited on a support.

32. The device as claimed in claim 18, characterized in that one of said filters is carried on the front face of said display surface.

33. A device chosen from among a personal digital assistant, an organizer, a telephone, a games console, a portable computer, an Internet access terminal, an automatic teller machine, a dashboard, a watch, a remote control, a portable music player, a positioning system and an audiovisual signals receiver, an item of electronic, office or leisure equipment, a facsimile machine, a photocopier, a scanner, a reader of recorded media, a home automation installation, an electrodomestic appliance, an item of medical equipment, a measurement apparatus, an automated analysis device, an item of automobile equipment, a signboard, a switch, a games device, a decorative element, a lamp, an electrical button and/or a display panel, characterized in that it comprises a display device as claimed in claim 18.

34. A display method which comprises:
a step of turning off a light source of a device comprising:
at least one filter termed “upstream” carrying a message to be displayed,
at least one second filter carrying a message to be displayed that is different from the message carried by each upstream filter,
a partially reflecting element placed downstream of at least the upstream filter,
the light source being suitable for illuminating each said filter, by backlighting and
a step of turning on said light source so as to reveal a message carried by an upstream filter.
